(19) United States
(12) Patent Application Publication
(10) Pub. No.: US 2005/0102534 A1
(43) Pub. Date: May 12, 2005

(54) System and method for auditing the security of an enterprise

(76) Inventor: Joseph D. Wong, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/706,629

(22) Filed: Nov. 12, 2003

(51) Int. Cl. H04L 9/00

(52) U.S. Cl. 713/201

(57) ABSTRACT

A method and apparatus is provided for auditing the security configuration of an enterprise having plural nodes. The method comprises collecting security information from the nodes of the enterprise under audit, analyzing the security information and providing a first result of this analysis; and then comparing this first result with a second result comprising security standards applicable to the enterprise under audit and one or more other enterprises that together form a relevant peer group, the result of this comparing step indicating the security of the enterprise under audit relative to that of the peer group of enterprises. The apparatus comprises an apparatus that carries out these same steps.

U.S. Pat. No. 6,192,410 which issued to Christopher S. Miller, et al. on Feb. 20, 2001 and U.S. patent application publication No. 2002/0169738 filed by Peter Van Giel, et al. which was published on Nov. 14, 2002 are hereby incorporated by reference into the present application for all purposes.

### BACKGROUND OF THE INVENTION

1. Field of the Invention

The present invention relates generally to the field of auditing the security of an enterprise, and more particularly to a method and system for assessing and benchmarking the security configuration information of an enterprise.

2. Description of the Related Art

Enterprises today are becoming more and more dependent upon information technology services. Outages or interruptions of such services are becoming more and more disruptive. Enterprises now normally require continuous operation of their information management systems. The equipment comprising such systems needs to be configured to maintain both continuous and optimal operation at all times.

The configuration of the security elements of such systems forms a critical part of their overall configuration, insuring their reliability and continuous operation. To optimize the configuration of such security elements, an enterprise will need to perform an audit of its security configuration. A typical security audit normally requires a complete analysis of the security of the elements of an enterprise's infrastructure.

At present, such an audit or analysis of a system's security configuration may be accomplished by either software installed at one or more enterprise sites, or by a technician stationed at one or more sites, or by both in combination. Examples of currently used security configuration audit software packages include CyberCop™ Scanner and Monitor (from Network Associates, Inc.); ISS Internet Scanner, ISS System Scanner, and ISS RealSecure® Network/OS/Server Sensor and Intrusion Detection/Protection (from Internet Security Systems, Inc.); and Network Intrusion Detector, Safepatch, and AIS Alarms (from the Department of Energy). These products are used to perform certain automated security checks for a range of operating systems and devices. These products compare an enterprise's infrastructure against a hypothetical set of uniform security standards—i.e., a long uniform checklist of security tests that must be passed. The products listed above arbitrarily favor the use of more security measures and a greater security grade within each measure that is taken. A somewhat better approach would be to judge a computer's infrastructure against coarse-grained hypothetical high, medium, and low security standards—for example, the multi-level security standard included in Microsoft's Internet Explorer version 5.5.

A drawback of current security software products is that they fail to answer key enterprise management questions relating to such things as whether a given enterprise includes too little, the right amount, or too much security. Without having answers to such questions, a manager may find it difficult to justify continuing existing security expenditure levels, adding security upgrades, or streamlining security. The present invention was developed not only to pose and to assist management in responding to such key questions, but also to indicate what actions management can take to first determine and then maintain the most rational level of security for a given enterprise, given the nature of the business.

With the current software packages, proper and complete audit or analysis will likely require an enterprise manager to bring on site expensive, certified security consultants with industry specific experience and then have them collect, analyze, assess, and adjust the configurations of devices attached to the enterprise's network. If these consultants work off site, they will need to establish holes through the enterprise's firewall to collect security information for analysis, or else they will have to employ manual labor to work around the firewall.

Establishing a hole in a firewall does have a drawback—the hole weakens the firewall, thus making it less secure. If an enterprise manager desires to and is capable of making another hole or enlarging an existing hole in a firewall, not only does the enterprise bear the expense and risk associated with reconfiguring the firewall, the enterprise also bears the risk of operating with a weakened firewall that may also provide reduced services to users. If such a manager is unable to make changes to the firewall or does not wish to weaken the firewall, then an audit of enterprise security must typically be limited to information that can be obtained from just one side of the firewall environment, or else the enterprise manager will have to employ consultants to do manual work on both sides of the firewall.

Because of these difficulties, in some enterprises it has proved impractical to use the currently marketed software products to perform security audits. In such cases, the enterprise manager may decide to perform an internal audit or to hire an outside company to perform an audit. Such an audit usually involves the following five steps: (1) Resources-finding someone with certified security knowledge and industry specific background do this system security audit; (2) Configuration-looking at complex enterprise configuration information either directly or by collecting all the relevant security configuration information needed for the investigation; (3) Analysis-coming to conclusions; (4) Reporting-documenting the findings and presenting this information to those requesting the audit; and (5) Action Plan-creating an action plan to address any problems uncovered and to propose changes for the security configuration.

There are several issues or problems along the way that need to be addressed if a successful security audit is to be achieved.

Resources. The enterprise manager must find the right personnel. To audit the security system configuration, a person requires practical industry-specific regulatory experience as well as a strong knowledge of general security technology. Although there exist general certifications for general security technology, each industry is often held to a different standard due to disparate regulatory or controlling authorities (e.g.: the Health Insurance Portability and Accountability Act for the health care industry, the Transportation Security Administration rules for airports, the Department of Defense standards for defense contractors, the Department of Energy orders for nuclear bomb plants, and the Nuclear Regulatory Commission rules for nuclear power plants). The successful candidate must have both sufficient technical and professional skills plus knowledge of the relevant industry specific rules. Typically, the staffing manager may need to balance industry specific regulatory awareness against general security technology awareness. And typically, no single person can be found who possesses sufficient expertise in all of the required areas. Time and money constraints limit the resources available for an audit activity, limiting in turn the content of the audit (its depth and breadth) and also its quality. For any number or reasons, a manager may wish to hire a third party to handle the security audit. A comprehensive security audit may take several weeks to complete. Assuming approximate rates of $2000 per day per certified security consultant, a security audit can become quite costly.

Configuration. Any audit of security begins by gathering the necessary security configuration information. Sometimes, the security information may have been obtained previously, but it may be in a format unsuitable for analysis.

In most cases, this security configuration information must be retrieved from the enterprise. If the security audit is being performed by an outside consultant, manual interaction with the individual computers within the enterprise is usually unavoidable. There is a risk that this interaction may cause new problems with the computers, and the enterprise manager is likely to blame the outside consultant for any perceived problems with the networked system that later arise regardless of fault.

Today, software tools are available that can collect configuration information. If such tools are developed locally by the enterprise, their reliability and maintenance becomes a matter of concern, particularly since such tools are typically incomplete when first developed. The quality of tools developed locally is also limited by local expertise. Such tools must be installed on an enterprise's computers, and the installation process may make the system unavailable or may cause it to crash. To avoid this, an enterprise manager is quite likely to challenge the rationale as to why such tools and their information gathering capabilities need to be installed on a given enterprise's systems. The managers of enterprises having rigid change management protocols or security measures in place will not allow the installation of such new tools on short notice and without careful system compatibility testing.

Analysis. After security configuration information is collected, the analysis of that information can begin. Analysis performed at an enterprise site may require multiple visits by the auditing consultant. This is valuable time lost. In addition, there are typically limited resources available on-site to assist with analysis. As part of analysis, it needs to be determined what elements of each node within an enterprise must be analyzed and what parts of the analysis should be identified and performed on each node. Both of these questions are typically addressed and answered by a single individual. Because of the limited knowledge of that individual, the analysis may not be sufficiently exhaustive or representative. To insure a reliable and stable enterprise environment, it is important to have a well-defined list of the items that are to be checked and of the criteria of satisfaction that is to be met. To develop such lists and such criteria, it would be advantageous to receive input from multiple sources of expertise, but this is rarely ever practical. Existing security analysis systems and processes are unable to test against a uniform security standard having, for example, two or three or more levels (low through high) of desired security and implemented in a way that also achieves full regulatory compliance with any applicable industry-specific regulations.

Reporting. Once the analysis is accomplished, issues identified through analyses are not normally organized in a manner logically suited to the needs of an enterprise's management. Information identifying issues of concern should be sufficient to provide an adequate description that is to the point, professional, and accurate, and that also meets the needs of different audiences (technical and non-technical, for example). More information should be available to those that desire it. But typically the information presented in reports reflects one individual's personal vision as opposed to a recommended uniform practice. This results in inconsistencies among deliverables, sending mixed messages to management. It turns out to be important, yet difficult, to assign the correct description to each piece of the information that results from analysis. This would appear to be obvious, but it becomes less so when one is handling similar pieces of information gathered from the analyses of differing systems in differing enterprises.

The reports should be consistently formatted. Technical personnel should not have to spend their time writing reports when their technical skills may be used in better ways. This suggests the need to employ personnel skilled in technical writing. The reports must also reflect the limitations and needs of the particular audience that requested a given audit. The audience may include technical management, non-technical management, sales staff, and others. Ideally, a security audit system should be capable of crafting different reports for different audiences, with the results of any given analysis presented in accordance with the auditor's request.

Action Plan. Typically, the staff performing an audit must prepare an action plan that resolves the issues by proposing changes to the security information which is identified. If an enterprise does not correct security problems aggressively, the enterprise may suffer service outages due to external hacking and hence may not be able to perform online business transactions. However, the enterprise and its staff are frequently given little assistance by the auditing enterprise in creating an action plan. The preparation of the action plan is facilitated when each security issue identified can be associated with a scenario that presents the steps necessary to resolve each specific issue, together with links to additional reference material.

As indicated above, the management of an enterprise may use commercial software products or manually-performed security audits or both to determine the security configuration of an enterprise. Regardless of the method used to perform the audit, neither method normally takes into account the objectives of the enterprise nor the specialized security needs of the industry in which the enterprise operates to the degree that is desirable. For example, the objective of a university is to allow the university community to collaborate with others and to facilitate the free exchange of information. Consequently, universities may require less stringent security measures that enable and enhance the free flow of information. The objective of a defense contractor, on the other hand, for obvious reasons, is to provide a greatly restricted flow of information between a much smaller set of users, and very strict security measures are called for in that environment. Unfortunately, there is no software or manual method of auditing that takes such differing objectives of differing enterprises into account, comparing the security measures employed by a given enterprise with security measures employed by other enterprises in the same industry or in similar industries. To compare the security measures of a university with those used by a defense industry would suggest the imposition of unduly harsh and unwanted security measures upon the university.

### SUMMARY OF THE INVENTION

Briefly summarized, an exemplary embodiment of the invention may be found in a method for auditing the security of an enterprise including plural nodes that comprises collecting security information from the nodes of the enterprise under audit; analyzing the security information and providing a first result of this analysis; and then comparing this first result with a second result comprising security standards applicable to the enterprise under audit and one or more other enterprises that together form a relevant peer group, the result of this comparing step indicating the relative security of the enterprise under audit relative to that of the peer group of enterprises.

The invention may also be found in a system for auditing the security of an enterprise that comprises collectors associated with a plurality of nodes within an enterprise under audit and arranged to collect from the nodes information concerning the security of the enterprise under audit; a security analyzer arranged to analyze the information concerning the security of the enterprise under audit and to provide a first result of this analysis; a data base containing a second result comprising security standards applicable to the enterprise under audit and one or more other enterprises that together form a relevant peer group; and a comparison mechanism arranged to compare the first and second results to determine the relative security of the enterprise under audit in comparison to that of the enterprises in the relevant peer group.

### BRIEF DESCRIPTION OF THE DRAWINGS

FIG. 1 is an overview flow diagram of an automated method for analyzing the security of an enterprise.

FIG. 2 is a block diagram illustrating the system components of an embodiment of an enterprise security analyzer system.

FIG. 3 is a flow diagram of an illustrative embodiment of an enterprise security analyzer method applicable to password security analysis.

FIG. 4 is a block diagram illustrating the system components of an embodiment of an enterprise security analyzer system optimized to analyze password security.

FIG. 5 is a flow diagram of an illustrative embodiment of an enterprise security analyzer method applicable to file security analysis.

FIG. 6 is a illustrative embodiment of a report summarizing the security analysis of an enterprise.

FIG. 7 is a flow diagram illustrating one way in which predefined questions can be administered to the users of enterprise computers and can then be graded.

### DETAILED DESCRIPTION OF THE EMBODIMENTS

Definition of Terms

The following terms used in this application shall have the respective meanings ascribed to them below unless otherwise expressly defined in this application.

Enterprise. An enterprise is a collection of computers, software, and networking that interconnects the computing environment of an organization of people. An enterprise normally has a name that may be used as a retrieval key to access information gathered from or reflecting the state of the enterprise.

Node. A node is a particular device in an enterprise, other than information pathways, to which or from which or through which information may flow over an enterprise network. Nodes normally have a network address, and some may also have names. Examples of nodes are servers, work stations, other types of computers, printers, routers, switches, and hubs. (A multi-processor may be considered a single node or multiple nodes.)

Field Computers or Field Nodes. Field computers, or field nodes, are computers or other nodes that are installed at enterprise sites. The operation of field computers or field nodes may be monitored from a central site which may (or may not) lie outside of any enterprise site.

Element. An element is one or more physical devices (CPUs, nodes, computers, hardware, storage systems, etc.) or logical devices (programs or software, firmware, volumes, directories, files, databases, threads, processes, functions, etc.) within an enterprise that can be monitored and/or managed.

Configuration Information. Configuration information is any information specific to the static or dynamic configuration of one or more elements or classes of elements residing on one or more nodes at a given point in time or over a range of time.

Security Information. Security information includes configuration information and also other information relevant to the analysis of the security of an enterprise. Other information includes, for example, information relevant to security gathered from computer users and administrators by means of questionnaires or contained in personnel or other files and data bases.

Collectors. A collector is a command, or a series of commands, that access, or that cause other programs installed at nodes to access, a node (or nodes) to gather configuration information about the node (or nodes) and its (or their) elements and then to return this information to a central site for analysis. (See also “questionnaire” defined below.)

Configuration Tracker. A security configuration tracker is a collector which gathers security configuration information from one or more nodes over time and which highlights changes between snapshots of this information gathered at different times.

Questionnaire. A questionnaire is a specific type of data collection instrument that gathers information from one or more human beings having access to a computer or other node, thus functioning as a special type of collector.

Daemon. A daemon is a specific type of program or agent designed to work as a background task on a computer. In the present context, a daemon may function as a collector or security configuration tracker that runs in the background monitoring ongoing operations.

Tracker Database or Repository Database. A tracker database or repository database is a database containing configuration information gathered by collectors, and in the present context security-related configuration information defining the security of nodes and elements, gathered from one or more nodes of one or more enterprises or from humans, and thereby facilitating evaluation or analysis, comparison, and report generation.

Analyzer. An analyzer is a program or rule or other set of instructions defining how configuration information gathered from a node is to be analyzed to develop information for later use in reports and in comparative studies. Analyzers may also identify issues of concern that should be reported to enterprise management. Each analyzer normally operates upon information defining the configuration of a particular class of elements. A set of analyzers can be assigned to analyze the configurations of many or all of the monitorable or manageable nodes and other elements of an enterprise.

Security Analyzers. Security Analyzers are analyzers that analyze configuration information, and possibly other information, gathered by one or more collectors and relevant to enterprise security. Security analyzers process and present this information in ways that facilitate the measurement of enterprise security, the comparison of such measurements with industry norms, and the preparation of management reports on enterprise security.

Analyzer Harness. An analyzer harness is a framework or other system which executes or interprets one or more analyzers, providing the analyzers with collector information relating to a specific node or set of nodes of a specific enterprise each time the harness executes an analyzer.

Issues. Issues are conditions or configurations and also data that, following analysis, may need to be reported to and may then need to be addressed by management. For example, the presence of an excessive number of easily-breakable passwords within an enterprise is a security issue that may require management to conduct additional user training or to employ stronger bad password rejection measures.

Security Audit. A security audit is a formal examination or verification of the security of an enterprise, preferably including (among other things) the configuration of its nodes and other elements, the attitudes of its personnel, and the degree to which physical security policies are actually implemented. Such an audit begins with a thorough examination or verification, followed by an evaluation or analysis of the information gathered. The result of this evaluation is preferably then compared to industry or peer group norms or averages or statistical results or to relevant industry standards. Security reports are then generated, and commands that improve security by altering the configuration of the nodes may also be generated and applied to the nodes. Preferably, there should be a high depth of coverage on each node, but sampling techniques may sometimes be used to advantage. Typically a significant breadth of coverage is desirable, possibly including multiple domains, for example. But more limited, specialized security audits can also be desirable and useful.

Peer Group. The relevant peer group of an enterprise that is being audited can be defined in several different ways: For example, it can be enterprises assigned to the same business category as the enterprise; enterprises involved in the same (or a similar) industry or business as the enterprise (health, education, military, etc.); enterprises having computers configured similarly to the enterprise's computers (considering both systems and business configuration); or enterprises required to comply with the same security standards as the enterprise; or a combination of these.

Token. A token is a string of one or more printable characters, any permissible character for passwords including the space character if permitted by other operating systems. For UNIX, the password character set will be interpreted as a subset of the standard specification of the 7-bit US-ASCII character set found in the following document: “7-bit American Standard Code for Information Interchange (ASCII),” ANSI X3.4-1986. In the context of the present invention, a token normally includes a sufficient number and variety of characters to be usable as a user, computer, group, network, or other type of password.

Detailed Description

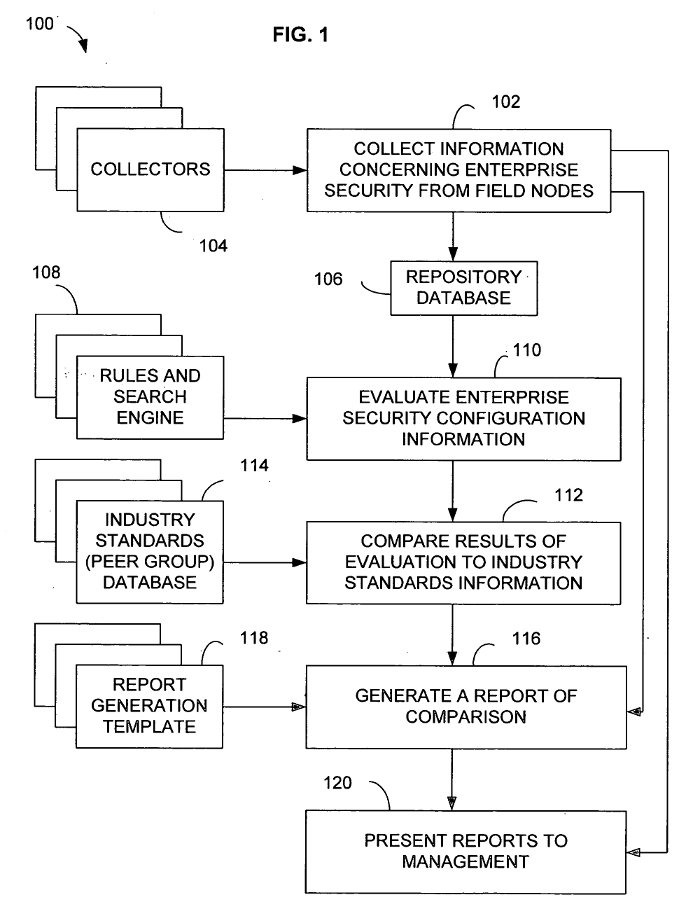

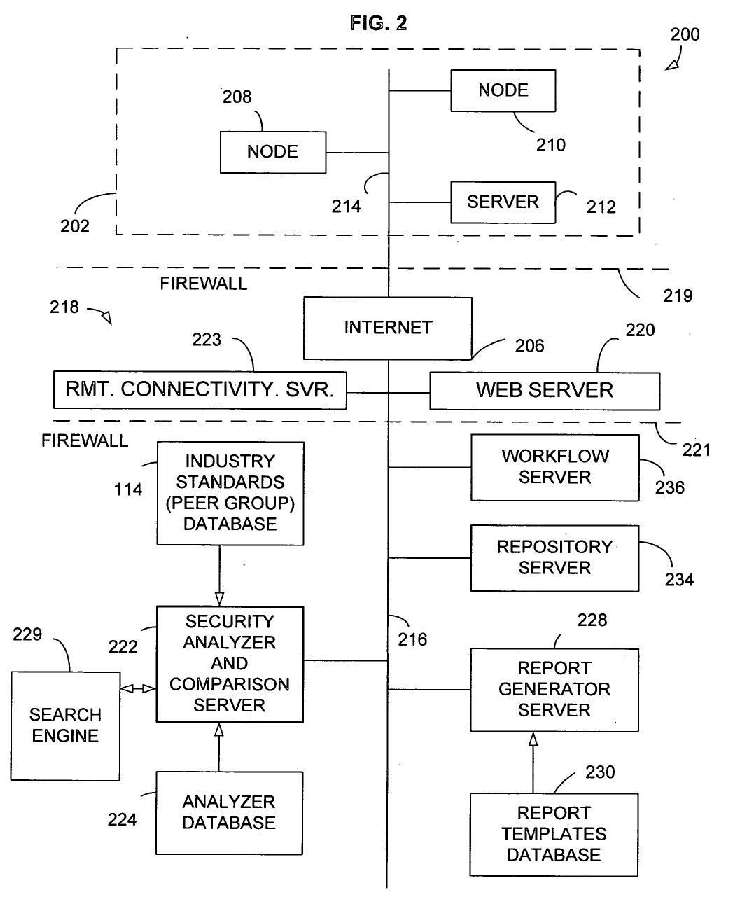

Referring to FIGS. 1 and 2, FIG. 1 presents an overview block diagram of an automated method 100 for analyzing the security configuration of an enterprise. The method 100 may generally be divided into four stages, as is shown in FIG. 1: collection (step 102), evaluation or analysis (step 110), comparison (step 112), and reporting (step 116). FIG. 2 presents a block diagram of the components of an embodiment of an enterprise security analyzer system that can carry out the method steps illustrated in FIG. 1. An enterprise 202 having (for illustrative purposes) three nodes 208, 210, and 212 interconnected by a network 214 is connected through a firewall 219 by the Internet 206 to a central site 218. At the central site 218, a central web server 220 and a remote connectivity server 223 are connected through a central site firewall 221 by a network or LAN 216 to a set of system components that perform security evaluation or analysis 110, comparison 112, and report generation 116. (An enterprise will normally have many more nodes than are shown in these figures.)

In step 102 of the method 100, enterprise security and configuration information is collected from the field nodes 208, 210, and 212 (FIG. 2). The collection step 102 is carried out by a set of one or more collectors 104 which gather the desired configuration information, including security-related information, from elements residing on or associated with the nodes 208, 210, and 212 and including the nodes themselves as elements. The collectors 104 may reside at the central site 218, or they may reside upon a support node within the enterprise 202, or they may reside upon one or more of the individual nodes 208, 210, and 212. They may also call upon programs or other collectors or agents or daemons residing on the various nodes to gather the necessary information. The collectors 104 gather and, optionally, preprocess information relating to element security and, more generally, element configuration. This information is then conveyed in some manner across the local enterprise network 214, the Internet 206, and the central site network 216 into the central site 218, passing through the enterprise firewall 219 and the central site firewall 221 while in transit. Ultimately, this information is stored in one or more files and/or in one or more databases at the central site 218 within some form of tracker database or repository database 106 (FIG. 1) which might, for example, reside in a repository server 234 (FIG. 2).

In one embodiment of the invention, the tracker or repository database 106 contains, for each of the nodes 208, 210, and 212, a configuration information file or data set or record or set of records that is created and maintained at the central site 218 by the collectors 104. Such files or data sets or records are also each normally associated with an enterprise name, a node name, and optionally some form of collector identification, along with the time and date when the information was gathered. The element (or class of element) that the information relates to may also be identified in some manner—the names of files examined or of disk drives checked out or of hardware elements tested or of programs verified, for example. And if the information was gathered by a configuration tracker, or even if a normal collector has gathered information at different times and/or on different days, then ranges of times and dates may be associated with ranges (or arrays) of corresponding information gathered over time. The collectors may run automatically and periodically, or they may have been run especially for a given security analysis procedure, or they may have been run at the request of an operator to facilitate the generation of a special report of some kind. Information gathered for other purposes or gathered as a matter of course may already be present within the repository database 106, or information in some other form and/or stored somewhere else may have to be brought in, transformed if necessary into the correct format, and then added to the tracker database.

The information gathered in this manner by the collectors 104 may be gathered by them and then transferred to the tracker or repository database 106 (within the repository server 234), with the assistance of a remote connectivity server 223, using techniques that are described in U.S. Pat. No. 6,192,410 which issued to Christopher S. Miller, et al. on Feb. 20, 2001. (U.S. Pat. No. 6,192,410 is incorporated by reference at this point.) As another option, the gathering of data by collectors into a tracker database or repository database 106, its subsequent analysis or evaluation, and report generation may be carried out as described in U.S. patent application publication No. 2002/0169738 filed by Peter Van Giel, et al. (application Ser. No. 09/851,963 filed May 10, 2001 and published Nov. 14, 2002). (U.S. patent applications publication No. 2002/0169738 is also incorporated by reference at this point.) These two publications disclose and describe how communications may be established between remote enterprise sites and a centralized set of servers such that information gathered by collectors located at the remote site can be conveyed to a tracker or repository database that is typically located at a central site. For example, see FIGS. 1, 2, and 3 and the accompanying text of the '738 application publication. The '738 application publication also describes the use of an analyzer harness and a set of analyzers, which may be written in Java, C, or Perl, to analyze the data gathered by the collectors to identify various types of issues and to perform computations. In addition, it describes the generation of reports of varying types presenting these issues to varying audiences. See, for example, FIGS. 8 and 21 and the accompanying text of the '738 application publication.

The present invention contemplates the use of analyzers which may be constructed as described in the '738 publication. Some of these analyzers may be called security analyzers, since they evaluate 110 security-related information gathered from specific elements or classes of elements whose configurations have an impact upon the security of the nodes 208, 210, and 212 within one or more enterprises 202. The results of this evaluation 110 is in such a form that it is a measure of some aspect of security which is in a form suitable to be compared 112 with information retrieved from an industry standards (or peer group) security database 114. After this comparison 112, security reports are generated 116 by the report generator server 228 which may operate in a manner similar to the manner of operation of the report generator described in the '738 publication. In some cases, conventional computer programs or subroutines written in Java or Perl or the like may be used instead of or in addition to analyzers to perform the evaluation, comparison, and report generation steps, particularly where access is needed to database servers or to the Internet during the evaluation and comparison process.

In step 110, the enterprise 202's security configuration information about elements or classes of elements is evaluated and analyzed to determine the level of security that is maintained within the field nodes 208, 210, and 212 of the enterprise 202. As part of this evaluation process, a security analyzer residing on the server 222 calls upon analyzers contained within an analyzer database 224 to investigate particular security configuration information that is associated with particular managed elements or classes of elements present on each field node 208, 210, and 212. As is described more fully in the '738 application publication (cited above), in one embodiment these analyzers are harnessed by some form of analyzer harness and are exercised against security configuration information previously gathered from the individual nodes 208, 210, and 212 of the enterprise 202 and residing within the tracker database or repository database 106 on a repository server 234. Following step 110, the results of this evaluation, and in particular any information defining security issues identified by the analyzers, are compared in step 112 to the results of prior analyses of security information gathered previously from a relevant peer group of other similar enterprises, companies, or agencies involved in the same or in a similar industry as the enterprise being audited, or otherwise having security needs that are similar to those of the enterprise being audited. The results of prior analyses of the relevant peer group are sometimes referred to as the “industry standards security information” which may be conveniently stored in an industry standards (or peer group) information database 114. If there are mandated and established industry standards or guidelines, then these mandated industry standards can be used instead as a source of comparative information.

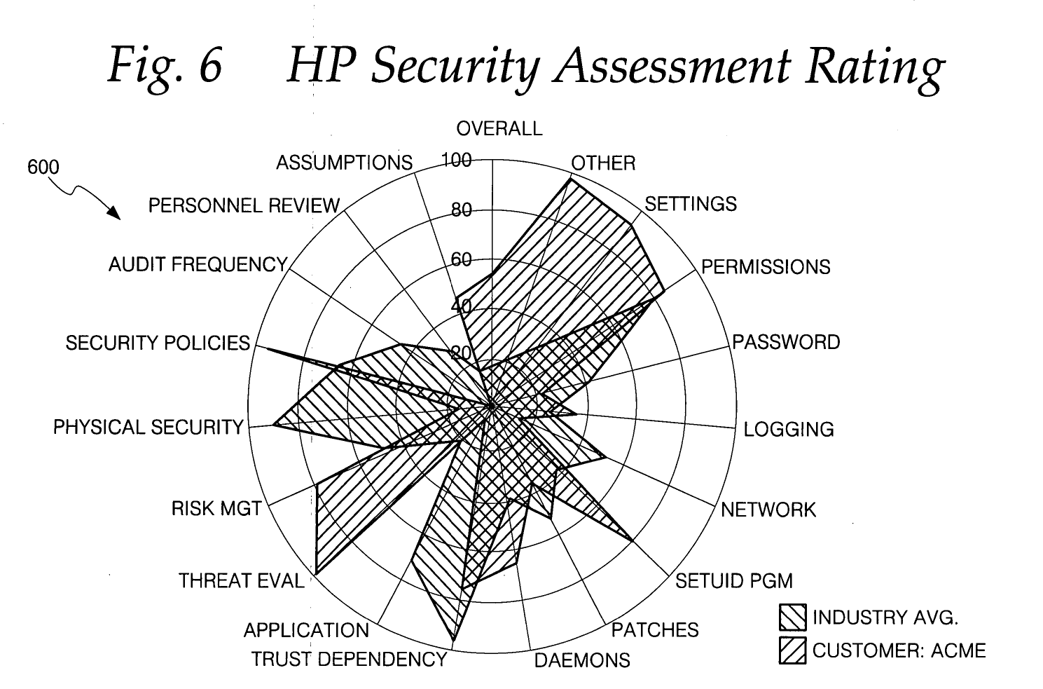

The reports generated following such a comparison focus upon the relative adequacy of the security measures in place within the enterprise being audited in comparison to the security norms in comparable enterprises, as is illustrated in FIG. 6, instead of focusing only upon the general security status of the enterprise. Accordingly, support engineers, and in particular engineers who may be skilled in enterprise security but not necessarily skilled in the security problems of the particular type of enterprise being audited (military, medical, academic, general business, etc.) do not have to wade through large amounts of security configuration information to identify and isolate problems—the security problems are highlighted by the comparative reports. Also, support engineers not necessarily skilled in the security aspects of enterprises in general do not have to concern themselves with failing to address some important security issue, since all relevant and material security issues are automatically addressed.

At step 116, a report is generated that illustrates in detail the results of the comparison between the security configuration of the enterprise under audit and the industry standards or industry averaged information for comparable industries (see, for example, the report 600 presented in FIG. 6). In one embodiment, the report generation process is governed by report templates stored in a report templates database 118 (FIG. 2). The reports in this embodiment are generated 116 (FIG. 1) by a report generator server 228 (FIG. 2), and they may then be presented (step 120) to enterprise management, to technical management, to the field engineering team, and also (optionally) to some form of workflow system or healer system (some form of self-healing technology, of which examples are presented below). The reports generated for these differing audiences can be varied to match the specific needs and technical levels of understanding of these varying audiences. Different report templates are used for different audiences, with the report length and vocabulary adjusted accordingly.

Referring now more specifically to FIG. 2, there is shown a “high level” block diagram of a system 200 in which an enterprise 202 is connected to a central site 218 via the internet 206. The enterprise 202 includes a plurality of nodes 208 and 210 coupled to one or more servers (or server nodes) 212 via a LAN 214. The nodes 208, 210, and 212 typically contain application software and files. Some servers may be dedicated to serving as shared storage devices and may manage RAID-style arrays of hard disk drives. Arrays of servers may form large data bases. Some servers may serve as print spoolers and print servers, while others, sometimes organized into groups or “farms,” may serve as mutually interchangeable Internet hosts. Shared information is routed to, from, and between the several nodes 208, 210, and 212.

A typical node such as the server 212 includes the customary components of a computer including one or more CPUs, a network and/or other communications interface, an EEPROM or BIOS ROM which may be based upon flash memory, RAM (and possibly ROM) memory, and one or more disk drives as well as removable storage devices such as floppy disk drives, CD and DVD read and write drives, and the like. The node's network interface includes a suitable network card or chip (not shown) that serves as an interface between the server 212 and the LAN 214, which may be an Ethernet LAN, a token-ring LAN, a wireless LAN (IEEE 802.11b and its descendants or Bluetooth, or by means of some other longer range wireless network protocol), or combinations of these; and some nodes (or groups of LAN-networked nodes) of the enterprise may be interconnected by means of one or more WANs. The connection between the central site 218 servers and some the nodes 208, 210, and 212 of the LAN 214 can also be implemented by means of a telephone line network, even one having “dial-up” links.

A typical node such as the server 212 also has an installed operating system, which is typically deeply involved in the management of security throughout the enterprise 202. The network interface communicates with the operating system and with programs on each node, typically by means of a TCP/IP stack (not shown), or by means of a comparable stack that utilizes some other networking protocol (a Novell protocol, for example). Sometimes several networking protocols are in simultaneous use over a shared Ethernet or other LAN. The operating system manages program operation and also, with assistance from the TCP/IP stack, manages communication between programs and files, programs and other programs, and programs and users, even when these reside upon different nodes. At a higher level, the operating system permits the definition of users and of user accounts as well as the definition of groups of users. It permits files to be created, named, and assigned complex access and modification privileges, as will be explained more fully below.

On an enterprise-wide basis, and also on sub-portions of an enterprise, the operating systems installed on one or more nodes, in cooperation with management software, provide for various classes of super-users, such as the managers of the enterprise, who are empowered to create and to enforce various security measures. For example, the super users are empowered to assign names and also passwords to individual users; to assign the users to groups; to establish for individuals and for groups their privileges to access files, data bases, servers, and communications; and, more generally speaking, to control who may see what, who may alter what, and who may communicate with whom and with what, over the entire enterprise and over portions of the enterprise as well as across the Internet. The firewall 219 is also regulated by the enterprise managers to regulate just what type of communication is permitted into and out of the enterprise 202.

The most common security-enabling operating system choices today are variants of Unix (e.g. IBM AIX, HP-UX, Sun Solaris, NetBSD, Linux, Tru64); Microsoft Windows NT, 2000, and XP; Novell Netware; Cisco IOS; and Brocade Fabric OS. In the embodiment of FIG. 2, Microsoft Windows 2000 or Windows XP are the operating systems installed on the server node 212 and on the workstation nodes 208 and 210 in one embodiment of the invention. Other embodiments may use UNIX, and some of the discussions presented below describe the use of UNIX commands in such an embodiment.

The central site 218 includes several servers that communicate over the internal LAN 216 and through the firewalls 221 and 219 with the enterprise site 202. Between the Internet 206 and the firewall 221, and lying outside of the protection of the firewall 221, there are two slave servers. The content of a web server 220 outside the firewall 221 is supervised by a repository server 234 within the firewall 221. The activities carried out by a remote connectivity server 223 within the enterprise 202 are supervised by a workflow server 236 within the firewall 221. The central site 218 may thus communicate with the enterprise 202 via the two secure slave servers 220 and 223 across the internet 206.

The central site 218 arranges for the web server 220 to enable users, enterprise managers, and security auditors working within the enterprise 202 to access action plans, to access and to generate reports, and also to download and use software for the auditing the security of the enterprise 202. The remote connectivity server 223 can be used to arrange for the passage of data and control commands over the Internet and through the firewalls in ways that do not interfere with normal enterprise operations. This is explained more fully below.

Within its firewall 221, the central site 218 includes a security analyzer and comparison server 222 that is coupled to a rule or analyzer database 224 and to an industry standards (or peer group) database 114. The central site 218 also includes the report generator server 228 and the report template database 230 described briefly above. The security analyzer and comparison server 222 uses rules or analyzers taken from the database 224 to analyze and to evaluate the security configuration of (and data gathered from) the enterprise 202. The analyzers analyze and evaluate the security information gathered by the various collectors 104, daemons, and configuration trackers that are arranged to monitor the nodes of the enterprise 202. The results of this analysis and evaluation are then compared to industry standards or averages taken from comparable enterprises. These standards and averages are stored in the industry standards (or peer group) database 114. The security information evaluation 110 and comparison 112 steps are discussed in more detail below in the context of several specific examples.

The report generator 228 in one embodiment receives the results of the comparisons and generates, among other useful reports, a report whose form is determined by a report template retrieved from the report templates database 230 to show the results of the comparison between the security analysis results and the corresponding industry standards. An example of one embodiment of such a report is illustrated in FIG. 6, where the results of the analyses and comparisons are presented in a circular graph format.

The servers associated with the central site 218 (220, 222, 223, 228, 234 and 236 as well as others) each include a suitable network card or interface (not shown) along with a TCP/IP network protocol stack or its equivalent (not shown) to connect them to the network 216.

The security analyzer and comparison server 222 just described may evaluate all kinds of enterprise security information automatically. By way of example (and without being exhaustive), this information might include the following:
(1) Security settings. The server 222 can determine which security features are enabled and which optional security-related programs are present. For example, it can: determine whether shadow passwords are being used (passwords that are kept in a file which is not accessible to the public, contrary to the norm with conventional UNIX systems); determine whether one-time passwords are in effect (passwords that can only be used once); determine whether Kerberos is active (a network authentication protocol designed to provide strong authentication for client/server applications by using secret-key cryptology, available from MIT and also available in commercial products); and determine whether SSH is present (secure shell by SSH Communications Security Corporation—a product that provides for secure connections over untrusted networks, including strong encryption).
(2) Access permissions and privileges control lists. The server 222 can gather information defining user and group access to files, data, and other objects, including computers. It can also determine which privileges users have, such as reading, writing, and executing permissions (this is described below).
(3) Password information. The server 222 can evaluate password vulnerability (this is described below).
(4) Logging information. The server 222 can evaluate the degree to which user activity is recorded for later study, and it can analyze this information.
(5) Network information. The server 222 can evaluate the allocation of certain system functions and powers to specific users.
(6) SetUID Programs. The server 222 can evaluate the various programs on the nodes of an enterprise that allow users to assume the rights of other users having more privileges, such as “SetUID” programs (described below) and other similar programs.
(7) Patches. The server 222 can evaluate the program patches (or repairs) installed on nodes during maintenance and upgrades and used to change and to correct the operating system as well as other types of programs, and evaluate the extent to which they are up-to-date and also reliable.

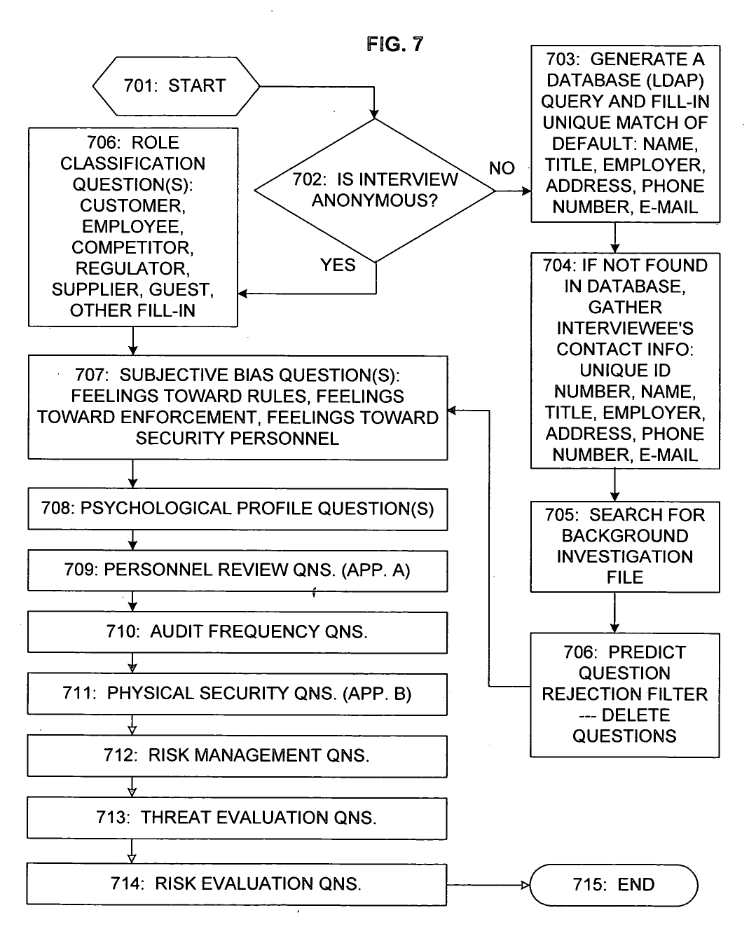

The information to be evaluated may be collected either by the collectors 104, as has been explained above briefly and as will be further explained below (in the context of password and file security). But information may also be gathered by other means, and in particular by having users respond to predefined questionnaires through interactive online surveys. This is illustrated in FIG. 7, and samples of questionnaires appear in the three Appendices.

Referring now to FIG. 7, in the first step 702 the computer classifies the interview as to whether it is to be anonymous or named. Both types of interviews are useful in security audits, and both types may be used as part of any audit procedure. An “anonymous” interview, for example, particularly if structured to give the interviewee assurances of the fact that the answers provided will never be traced back to the one providing the answers, may oftentimes be likely to elicit more honest answers relating to the personal attitudes and activities of both enterprise personnel and also outside users of an enterprise's computer resources as to security, as to crime, and as to criminal tendencies. (For example, the question sets 708 and 709 in FIG. 7 and in Appendix A may be more effective when administered anonymously). A “named” interview may be more useful when factual questions about security and security practices are asked, such as questions aimed at determining whether surveillance cameras are operative and whether security guards are performing their proper roles. With such interviews, the individuals providing the answers may need to be contacted individually at a later time to supply follow-up information. (For example, the question sets 710 and 711 in FIG. 7 and in Appendix B may be more effective when administered to individuals whose identity is known).

The interview process proceeds down separate paths in FIG. 7 depending upon whether a particular interview is anonymous or not. In the case of an anonymous interview, at step 706, the role of the one being interviewed is determined generally: Is the interviewee a customer? An employee? A competitor? And so on, generally categorizing the interviewee without asking for anything that might identify the interviewee.

If the interviewee is a known individual, then the interviewing process begins at step 703 where the computer, using either the computer identifier of the interviewee or some other form of identification supplied by the interviewee, attempts to look up the interviewee in a personnel database of the enterprise. For example, all of the enterprise employees working at an enterprise or enterprise site where the personnel all have qualified for U.S. government National Security positions will have filed the government Standard Form SF 86, and the information captured from that form will be accessible in some form of computer-accessible data base. (For example, the enterprise may have used the Department of Defense Electronic Personnel Security Questionnaire EPSQ86, which is an electronic variation of U.S. Office of Personnel Management's Standard Form (SF86) for Sensitive Positions.) A query to that database can populate the interview questionnaire with the necessary information, saving considerable time and trouble if the information is current. If an SF86 equivalent form has already been filled out by the interviewee, it is typically retrievable from a human resource database. If this type of information is not applicable to a particular industry group, then this step may be skipped, or other available sources of personnel information or the like may be utilized, as is explained in the following paragraph.

Other information, such as the interviewee's e-mail address, may come from enterprise user management records maintained by the operating systems within the enterprise. Such sources may provide some or all of the personal information that is gathered during the interview process. In many instances, for example, considerable user personal information may be stored in a database accessible by using an industry-standard LDAP (Lightweight Directory Access Protocol) protocol, which is widely used in conjunction with enterprise e-mail services. Other comparable sources may also be available within a given enterprise.

To the extent that the needed information cannot be retrieved from a database, at step 704 it may be gathered directly from the interviewee, for example by displaying a questionnaire form on a computer screen and then having the interviewee fill it in. This can be done using a PC with web browsing software and HTTP pages, for example, with the security turned on to insure privacy, or in any other convenient way. The amount of information gathered and available may vary considerably, depending upon the industry group and the nature of the security problems being addressed.

At step 705, in the case of some industries, a search may then be made for a file containing the results of a background investigation on the individual, and this information may be factored into the interview process. Thus, criminal records, financial records, alcohol and drug abuse records may be accessed and checked.

At step 706, in dependence upon the type of industry and the results gathered about this particular interviewee, a question rejection filter may be set up to delete from the interview which follows some or all of the questions in the various categories that are listed in FIG. 7 from step 707 to step 714. This can greatly shorten the interview process, making it much less burdensome upon and time consuming for the interviewees.

In many cases, the interview can be conducted “on line” from any computer available to the interviewee. In the case of some personnel, it may be easier to interview them at home or at work by telephone, with answers typed in by touch tone. In a few cases, however, it may be desirable to have at least portions of the interview conducted by a human interviewer to insure the identity of the interviewee, to be able to explain some of the questions, and to insure the interviewee's attention is held. But in the majority of cases, an unsupervised computer-conducted interview is the preferred and less expensive choice.

The interactive surveys presented beginning at step 707 in FIG. 7 can contain any computerized set of multiple-choice or short-answer questions that can be automatically scored by a computer and that relate to security. These can be graded based on pre-published grading standards for each given questionnaire form. When such a grading standard is not available, a computer can simply score the forms based upon the percentage of questions completed and the percentage consistency of the answers supplied with answers given previously by others. Examples of questionnaires that may be used for personnel review include the Overt Integrity Test (Aamodt), the Personnel Selection Inventory (London House), the Trustworthiness Attitude Survey (Psychology Surveys Corp.), the Pre-employment Opinion Survey (P.O.S. Corp), the Reid Report (Reid Psychological Systems), the Stanton Survey (Stanton Corp), the TrueTest (Integram, Inc.), and the Phase II Profile, Personnel Security Standard Psychological Questionnaire (Stone). An exemplary questionnaire designed for use in checking security policies is also published by Tom Peltier in Harold Tipton's Information Security Management Handbook (4^{th} Ed.) pages 210-212.

One embodiment of the invention might include the sequence of interviews covering various security-related topics that is illustrated in steps 707 to 714 of FIG. 7. Many other sequences and arrangements of interviews are, of course, also possible.

Step 707 asks a series of questions that check for the interviewee's subjective bias going into the interview process—how does the interviewee feel about rules, rule enforcement, and security personnel, for example.

Step 708 asks a series of questions relating to the psychological profile of the interviewee, viewed from the mental health point of view.

Step 709 asks a standard series of personnel review questions. An illustrative set of such questions appears in the Appendix A to this specification. This illustrative set of questions are typical of those asked of personnel when they are first hired to determine their personal integrity as best it can be measured through such an interviewing process.

Step 710 asks enterprise personnel how frequently audit procedures are actually carried out. For example, how often have they been forced to alter their passwords? How frequently are files actually backed up or copies of new versions stored in a version management system? Are their identity cards regularly checked when they come in and leave?

Step 711 asks a series of questions about physical security, such as those set forth in Appendix B of this specification. For example, questions are asked about the frequency of inventory checks and about the consistent use of bar codes on files, disks, and the like. Questions may be asked about the provisions for safeguarding portable and other valuable computers and whether they are actually utilized.

Step 712 asks questions about risk management. Risk management is a four-part process: identifying risks or threats, quantifying their impact, developing a cost-effective set of one or more controls for each risk, and then insuring that the controls are in place and working properly. A risk management questionnaire is one that asks employees questions to identify potential risks, to measure the extent to which the risks are impacting upon operations or increasing costs or creating the potential for exposures and losses.

Step 713 as questions about threat evaluation. This is also part of risk management—evaluating the severity of any exposures or threats that may have been identified either by analysis of data gathered by the collectors or as the result of answers provided during the preceding risk management interview. Are guards doing their jobs? Are unauthorized persons seen on the premises? Are doors and windows not properly secured? Are fire extinguishers present? Have fire drills been conducted? Are passwords and identification cards of former employees properly and promptly deactivated? Are outside third parties being given improper access to secure systems?

Step 714 asks questions that focus upon evaluating uncovered or known risks that the enterprise may face. A risk, for example, might be the destruction of an important, business-related data base. Various controls need to be in effect to minimize this risk—off-site duplicate back-ups, data base management personnel having no relationships with or to programmers and others who make use of or enter data into the data base, redundant servers in RAID type arrays arranged to provide continued database access even when disk drives fail to operate. Questions can be asked of personnel relating to all of these topics to determine if the necessary controls are active and working properly.

Each question set (for example, those prepared for steps 707 to 714) is accompanied by either a grading methodology or a set of correct answers and predetermined scoring formulas for use in grading and evaluating the answers provided. The content of the questions may shift over time and as an enterprise changes and grows. Examples of questions are presented for the steps 709 (personnel review) in the Appendix A. Examples of questions are presented for the steps 711 (physical security review) in the Appendix B. Examples of questions are presented for security policies in the Appendix C. These illustrate in general the asking of multiple-choice and true-or-false questions and also the simple grading methodologies that are available. Since the scored results are eventually compared to the norms within an industry peer group, scores achieved, for example, in a health care related enterprise need not appear inadequate relative to the scores achieved in a nuclear power plant enterprise. The same questionnaires and grading methods may be used in all types of industry settings, and the comparison step automatically adjusts the results presented in accordance with the particular nature of the enterprise that is being audited.

To illustrate the gathering of security information from the nodes 208, 210, and 212 of an enterprise 202, the analysis and evaluation of that information, the comparison of that information to industry norms, two specific examples will be presented: first, the process of evaluating password security will be illustrated and explained; and then, the process of evaluating file security will be illustrated and explained. These are two of the more complex areas that normally need to be addressed during an enterprise audit. Additional technical categories requiring evaluation and comparison are listed in FIG. 6.

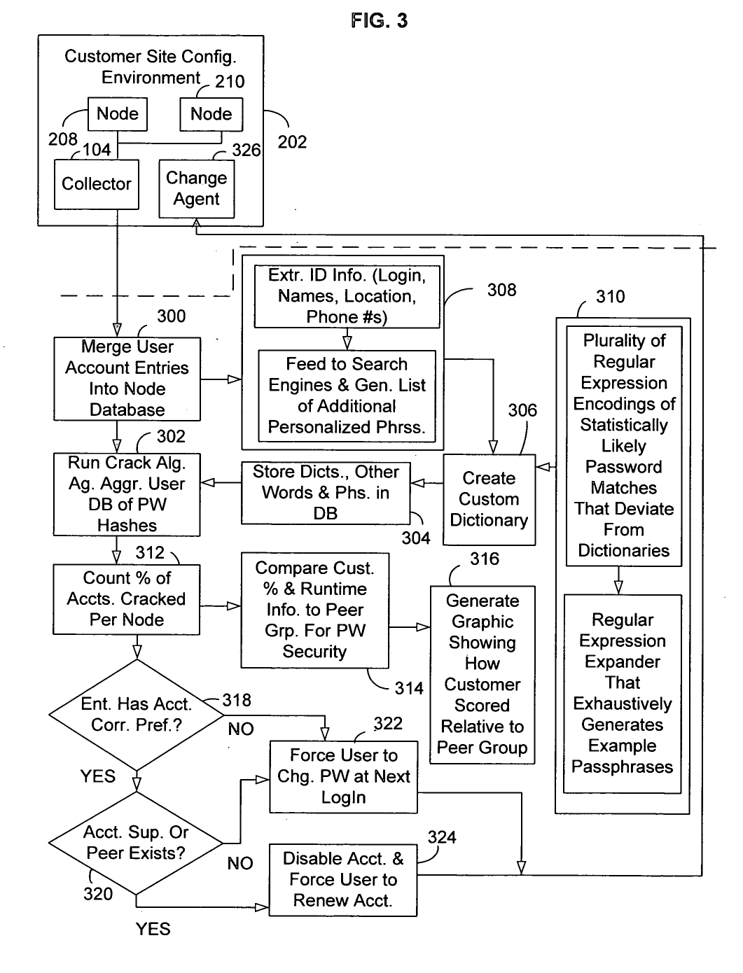

FIG. 3 presents a detailed block diagram of an exemplary embodiment of the security auditing system in which password vulnerability, as indicated by gatherable security configuration information, is evaluated and (in some cases) corrected. In FIG. 3, the enterprise 202 is shown again, this time with the two nodes 208 and 210 which are presumed to be servers having users that have been assigned user accounts and passwords. While only two nodes are shown, any number of such nodes, as well as PC nodes, can be present in any given enterprise. In general, and for the purpose of evaluating password vulnerability, each node is presumed to have one or more distinct user accounts. Records relating to these accounts are stored in a database along with residual information relating to user account passwords. (Other types of nodes, such as routers and the like, not having multiple distinct accounts may not need to be evaluated in this manner for password security.) The individual nodes do not necessarily store the actual user passwords—they may be maintained elsewhere on other servers, for example.

To evaluate security in general and password security in particular, the enterprise manager normally may begin by installing and operating a computer program that is downloaded from the web server 220 located at the central site 218, or the program may be delivered on some media to the site of the enterprise 202, or it may be preinstalled on an enterprise 202 server. This computer program, when it runs, prepares some or all of the nodes of the enterprise 202 for auditing by, for example, installing any necessary collectors 104 and by taking any other necessary steps needed to establish the necessary communications between the enterprise 202 and the central site 218.

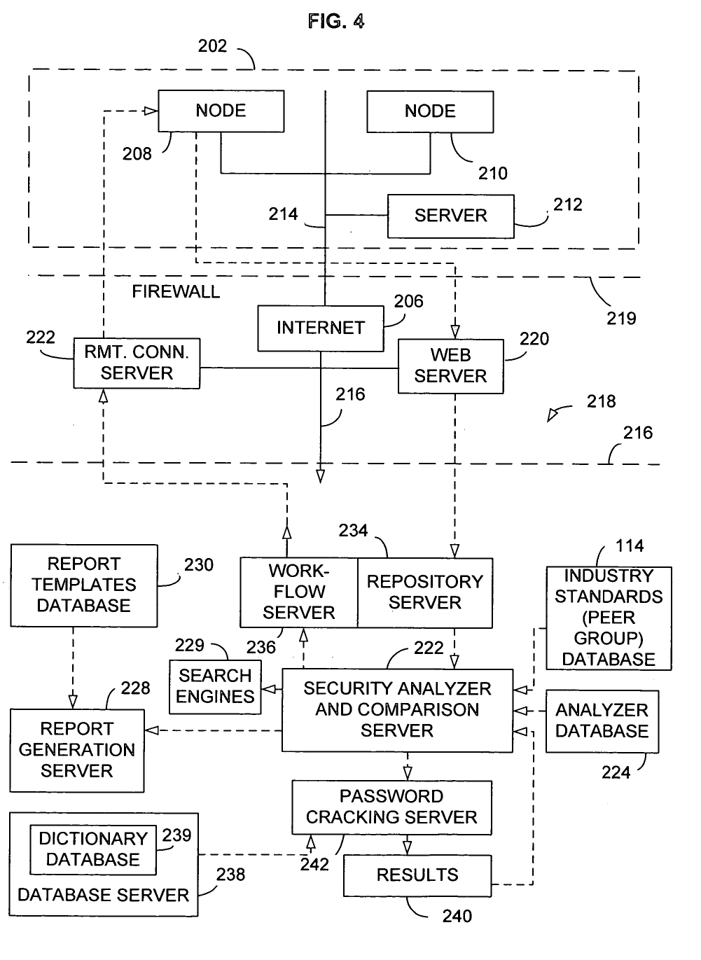

The auditing process then proceeds as is illustrated in FIG. 3, using an exemplary system configuration that is illustrated in FIG. 4. FIG. 4 contains, in addition to the elements discussed previously in connection with the discussion of FIG. 2, a password cracking server 242 and a database server 238 containing a dictionary database 239 which are used during password security evaluation in ways that will be explained.

In FIG. 3, one or more collectors 104 (FIGS. 1 and 2) gather information relating to passwords. Analyzers then process this password information, as has been explained generally above, and as will now be explained in more detail.

First, at the step 300, all of the user account passwords are gathered (normally by one or more collectors 104) from each of the nodes being evaluated. The passwords are then combined into an aggregate password database that may formed for each of the nodes 208 and 210. Alternatively, the passwords from several separate nodes, or from all of the nodes, may be aggregated together.

It should be noted that the passwords are not human-readable at this point. Each password is individually “hashed”, meaning transformed by some arbitrary hashing algorithm into a nonsense number of fixed size which cannot be readily translated back into the original password. (When a user, while “logging” onto a computer, types in a password to gain access to the computer, the newly-typed user password is also “hashed” in this same manner and is then compared to the stored “hashed” password of this same user. If they match, the user is permitted to log onto the computer. Accordingly, the actual passwords are never stored in human-readable form where they might be viewed or stolen.)

Step 302 next causes a conventional dictionary security and password attack program (i.e. “Crack” or “LOphtCrack”, for example) to test the security of the passwords by attempting to decode them. This can be done, for example, by taking a dictionary database 239 (FIG. 4) and applying the same hashing algorithm to the entire dictionary database 239 that is applied to the user passwords for one or more nodes. Next, the hashed password entries in the aggregated database obtained from the one or more nodes are compared, one at a time, to the hashed words taken from the dictionary database, looking for matches. Whenever a match is found, then the dictionary word that was hashed is the user's password. In that case, the user's password has been decoded successfully.

The hashing algorithm associated with a UNIX operating system is often called a CRYPT program. The CRYPT hashing algorithm within a UNIX operating system is normally callable through the standard application programmer's interfaces (API) that is included for authentication purposes as a library routine. In Windows, a comparable function is reachable by a special call to the NT LAN Manager.

The word and phrase database 304 preferably includes pre-defined dictionary words and phrases in a variety of languages such as English, Spanish, Italian, German, Chinese, Polish, Arabic, and Dutch. It preferably also includes terminology taken from dictionaries such as Jargon, Music, Tagalog, Movies, Proper Nouns, etc among other dictionaries, and also custom dictionaries, as will be explained.

The dictionaries can also be augmented, depending upon need, with words and phrases generated by a custom word and phrase generator 308 which finds words and phrases for inclusion in custom dictionaries 306 for each individual user. These can later be combined into the word and phrase database at step 304 for use in password checking at step 302. These custom dictionaries 306 can be created in several different ways. For example, a custom dictionary 306 is generated by extracting specific identifying login names, real names, locations, and phone numbers which can be obtained from user information, and by combining this with other personalized phrases that may be obtained, for example, by conducting Internet searches using the search engines 229. For example, simple Internet keyword search expansion trees or online background investigation database queries can lead to statistically likely additional passwords for any given individual. As another example, a plurality of regular expression encodings of statistically likely password matches can be generated, as just explained; and then at step 310 they can be further modified to deviate from the previously described dictionaries in ways that are consistent with a password policy requiring one number and one punctuation character to appear within every password. Such a regular expression expander can be arranged to exhaustively generate password phrases that conform to the known password policies of a given enterprise, thus demonstrating further password insecurities against a sophisticated attack.

More potential passwords can be gathered by using a simple web crawler robot routine. If the user's social security number is available, such a web crawling robot routine would have the extended capability for scanning credit reports for interesting proper nouns by tailoring the web query keystrokes for a credit bureau such as Equifax or Trans Union. One may also download publicly visible internet records, such as telephone directory listings. In addition, one may check internet background investigation reports from web sites such as “ussearch.com”. For example, one may seek out court judgements, birth dates, relatives' names, driving records and license numbers, pet licenses, real property holdings, and possibly other unique numbers and even social security numbers. These can be spell-checked with spell check utilities to eliminate words already present within the normal dictionary (which words have already been checked). Only the new words or phrases (potential misspellings) are included to further advance the dictionary password attack process. For example: if the user login attributes include a login name of “john_acme” and a real name of “John Acme,” with a telephone number of 415-555-1234 and no specified street address, then a web crawler robot can query an internet telephone database directory for LAST_NAME=Acme, FIRST_NAME=John and then use the specified telephone number to optionally narrow the search. The telephone directory can return a street address, city, state or province, and postal code. If any of these words or phrases fail the spell check, then they may be included in the password check to give a personalized and customized dictionary attack against the individual named “John Acme.” This can help the system to find novel pass phrase candidates such as “m00se-g00se” (absent from a spelling dictionary) as a pet name or “010103” as a birthday, phrases which would fail spell checks against a normal dictionary.

This process can be recursively reiterated as many times as may be necessary or desirable by taking the novel phrases found first and then generating new web-based queries from those phrases to extend the search for related pass phrases to the next level. One is simply exploiting the general observation that human beings are typically poor selectors of passwords containing purely random strings of characters-human beings much prefer passwords that correlate with known information.

One can also employ pre-published subroutines that take a regular expression pattern as input and then generate an expanded list of strings that satisfy the pattern. For example the regular expression [AB] {3} exhaustively expands to eight possible outputs: AAA, AAB, ABA, ABB, BAA, BBA, BBB, BAB

Once the crack password algorithms have been executed (step 302) and all of the comparisons between the hashed passwords and the hashed words and phrases and the like have been completed, at step 312 the system computes the percentage of user accounts whose passwords were successfully cracked. This value is normalized and recorded along with another value representing a normalized estimate of the percentage of CPU cycles per year that would be required to crack an average password (that is, what percentage of the commercially available annual CPU cycles are required, on the average, to generate a password match for an average account). For each node, these two averaged values are normalized and are then weighted equally. Adjustment in the normalization process is made for the periodic improvements in CPU performance that occur over time. In one embodiment, the percentage of cracked passwords is divided by two, the percentage of annual CPU cycles is also divided by two, and then these two numbers are simply added together to yield a composite score for the computers of that generation.

At step 314, this sum, representing the enterprise percentage information on password security, is then compared to the intermediate scores on password security for the related industry after those scores have been averaged together—i.e., information gathered from the enterprise's specific peer group that have been audited previously. For example, if the enterprise is a college or university, the enterprise information can be compared to relevant information gathered from other providers of educational services (North American Industry Classification System group #61). If the enterprise is in the fields of health care and social assistance such that the security requirements are derived from government published regulations, then the enterprise security configuration information can be compared to the applicable relevant standards for security information in the industry group that includes health care and social assistance (NAICS #62). Accordingly, an enterprise that is the educational services arm of a university is benchmarked against data gathered from other educational services institutions (including other universities), while a separate enterprise that is the health care and educational services arm of that same university is preferably benchmarked against a peer group of whichever group had the higher security assessment ratings: health care providers or educational service providers.

Next, at step 316 and as shown at 600 in FIG. 6, a graphic is generated to illustrate, in the password area as well as in other security areas of interest to enterprise management, a circular graph for this particular enterprise (named “Acme” in FIG. 6) illustrating how Acme scored relative to a second circular graph representing the industry average of a peer group of enterprises in related industries. The intermediate scores for the related industry used to generate the industry average graph shown in FIG. 6 may need to be re-averaged periodically to reflect any changes in the industry that have occurred or to facilitate the simultaneous introduction of a new industry group and the auditing of an enterprise that falls into that new group.

An illustrative comparative security audit report presented in the form of a circular graph is shown at 600 in FIG. 6. The graph is shown having 19 radial axes, 18 each representing individual areas of security assessment concern, and a 19th radial axis, vertically oriented, indicating an overall security assessment. In each case, the range of security assessment is indicated on a scale that extends from zero (at the center of the graph) to 100 (at the radially far edge of the graph), with circles indicating the security levels 20, 40, 60-, 80, and 100. The graph contains two circular plots, one presenting the security assessment for an enterprise named “Acme” shown cross-hatched from upper-right to lower-left; and other presenting the security assessment for the average of a peer group of comparable enterprises, shown cross-hatched from upper left to lower right.

In this plot, the “PASSWORD” security level is shown to be at the normalized level 40 out of 100 for the enterprise named “Acme” that is being audited. The industry peer group average “PASSWORD” security level is shown to be at the level 20 out of 100 for industries similar to “Acme.” Accordingly, fewer passwords were “cracked” during the audit of the Acme enterprise, or the Acme passwords required more CPU cycles to crack (or both of these) than was true for the average member of the related industry peer group. Thus, the enterprise Acme, while having a relatively low absolute password security level of 40, nonetheless is shown to have double the password security of an average member of the peer group of enterprises. This is clearly shown by the intersection of the two circular graphs plotted in FIG. 6 at 600 with the radial line labeled “SECURITY”.

The remaining absolute and comparative security assessment ratings shown in FIG. 6 for 18 separate areas of security concern are computed in a similar manner to that just explained after comparable gatherings of configuration and interview data and comparable computations of the various named aspects of enterprise security listed in FIG. 6 and comparable comparisons to industry averages or norms. Overall, as indicated by where the vertical radial line intersects the two circular graphs, Acme has an intermediate security rating of about 54, while the peer group has a much lower security rating of about 18.

Relevant industry standards and averages may be obtained by averaging together actual peer group information obtained from comparable peer group industries, or they may be obtained from relevant industry-specific standards, or both of these sources may be called upon to supply standards for comparison for use with respect to different aspects of security. Industry standards and peer group information may be generated by accessing the security standards reference account information for enterprises categorized within a comparable organizational category. One embodiment, for example, employs the North American Industry Classification System (NAICS) of organizational and industry group taxonomy groupings of enterprises. This was developed in 1997 by the Office of Management and Budget and the U.S. Census Bureau, and it has been compiled into a handbook by Cremeans (ISBN #0890590974). It supersedes the government printing office's earlier Standard Industrial Classification (SIC) Manual published back in 1987. As an alternative, particularly for international use, the United Nations has published a table which relates the earlier SIC to an International Standard Industrial Classification. Empirical information about the security of various peer group enterprises identified in this manner may be obtained by taking and then averaging together a sampling of security scores obtained from organizational group information accumulated from previous and current audits.

Returning now to the password security evaluation process set forth in FIG. 3, the process next proceeds to a decision step 318. At this point, a check is made of whether this particular enterprise 202, as its preference, permits a change in a password to be forced upon a user automatically when an insecure account password is found. If this type of change can be made automatically, then at step 322 the password expiration flag is set for all of the passwords that were successfully cracked. This causes the users of the corresponding accounts to be prompted automatically to supply new passwords the next time they log onto an enterprise node.

Even if password changes are not allowed automatically, a check at step 320 is made to see whether there is an account supervisor (or peer) available who can re-activate such an account promptly and manually. If not, then at step 322 the password expiration flag is still set, forcing the user to come up with a new password as just explained. But if an account supervisor is available, then at step 324 the account is completely disabled to prevent further logons by that user. This forces the user to renew the account by contacting the account supervisor, who may then give the user instructions on how to select a more secure password before re-activating the account. In certain industries with high security requirements, this may be the only appropriate way to respond to the problem of passwords that can be cracked.

Program execution, from both steps 322 and 324, then proceeds to software (not shown) which can communicate a security configuration change, by means of a change agent 326, back to the enterprise 202 and to one or more of its nodes 208 and 210, where password expiration flags are set or where accounts are deactivated in an effort to improve password security. The change agent 326 is part of a command execution interface between the central site 218 and the enterprise 202 which typically includes the remote connectivity server 223 and the workflow server 236. In essence, a system command shell is generated and executed that closely simulates an account supervisor manually invoking the commands that change the security configuration of the node 208, for example. Examples of available change agents 326 that include such remote shell command processors are the programs named RSH/NT and RSH which are available for versions of the Unix operating system.

If no change agent is present, then an enterprise manager may perform the function of the change agent 326, closing accounts and forcing the submission of new passwords.

Referring now to FIG. 4, the block system elements of the central site 218 are shown arranged somewhat in the manner of a flow diagram or process arrangement, with dashed lines showing information flow paths. This is different from FIG. 2, where many of these same block elements are shown simply interconnected by the LANs 214 and 216. In FIG. 4, the connections of the LAN 216 to the servers within the central site 218 are not shown but are omitted for clarity. Instead, the information flow paths are shown (dashed lines) to indicate the flow of information between the servers that communicate with each other while carrying out the process steps described in FIG. 3. And while separate servers are shown in FIG. 4 carrying out most major functions, these same functions may optionally be carried out by varying combinations of shared servers. The database server 238 and dictionary database 239, and also the password cracking server 242, plus the results 240 of the password cracking process, are shown as separate elements in FIG. 4 which do not appear separately in FIG. 2. But notwithstanding these differences in the drawings, the system shown in FIG. 2 and in FIG. 4 is essentially the same system.

The central site 218 includes a slave web server 220 located outside the fire wall 216. This web server 220 collaborates with, and is controlled by, a repository server 234 within the firewall 216. Together, these two servers may gather, or accept, information coming from enterprise 202 nodes (such as the node 208), store the information within the repository server 234, and then provide that information to other central site 218 servers, such as the security analyzer and comparison server 222. This is shown in FIG. 4 by dashed lines interconnecting these elements. The repository server 234 may also gather information from the central site 218 servers, such as from the report generation server 228 and the security analyzer and comparison server 222. Then the repository server 234 can make this information and also audit programs, audit reports, and other useful information available to enterprise site servers and PCs, such as the node 208. This can be done by means of Internet 206 access between the node 208 and the web server 220 over the network paths 214 and 216.

The central site 218 in addition includes a remote connectivity server 223 also located outside of the central site firewall 216 that collaborates with and is controlled by a workflow server 236 within the firewall 216. The workflow server 236 may be commanded to carry out scheduled and nonscheduled tasks at remote enterprise 202 sites, such as at the node 208 (as shown again by the dashed lines interconnecting these elements), working through both of the firewalls 216 and 219 and over the Internet 206.

The repository server 234 may function as a data warehouse containing raw inputs, real-time information, historical information, intermediate and temporary results, and final results. It thus can serve as the system's tracker database or repository database 106 (FIG. 1) and as a database from which the enterprise 202 administrators and also the staff at the central site 218 may retrieve information as well as interim and final reports. The workflow server 236 functions as a control harness which tracks the progress of each step in the workflow towards completion of a service. The workflow server 235 brokers and then schedules tasks and follow-up attempts when tasks fail, and it transitions the work between the various process modules which reside on the servers. For example, if a password process checking task has failed, the workflow server 235 has the option of rescheduling the task, skipping the one task but completing other tasks in a work assignment, or aborting the entire work assignment, in accordance with the severity or recoverability of the failure and other relevant factors.

The security analyzer and comparison server 222 is coupled to the password cracking server 236 information flow wise, as is shown by the dashed line interconnecting these elements. The password cracking server 242 uses the local operating system's CRYPT algorithm (or a comparable algorithm found within a particular node's operating system, possibly by running the CRYPT task remotely on a machine having the proper operating system) to hash the words found in the dictionary database 239 as well as other words obtained using the search engines 229 and the various techniques described above. It then compares these hashed words to the hashed passwords obtained from the node 208 or set of nodes 208 and 210 being analyzed. The results 240 of these comparisons are then returned to the security analyzer and comparison server 222 where the password security results are compared to the relevant information standards or averages relating to passwords for the industry peer group of the enterprise 202 and obtained from an industry standards (peer group) database 114.

Following this, the security analyzer and comparison server 222 performs or conducts additional analysis operations using specific security analyzer rules that are obtained from the analyzer database 224 to analyze the particular security information involved.

Once the security analyzer and comparison server 222 completes the analysis task, one or more reports can then be generated by the report generation server 228 using report templates obtained from the report templates database 230. A typical report will be a chart, graph or grid in which a score for the security information under study is illustrated in comparison relationship to same industry standards or average information, as is shown at 600 in FIG. 6. The reports may also include boilerplate text that is retrieved from report templates, combined with variable information obtained from the repository server 234, and optionally pre-processed in accordance with instructions contained within the report templates. The final reports are assembled into deliverables of various types each designed to suit the understanding level, needs, and vocabulary of the particular audience for each report.

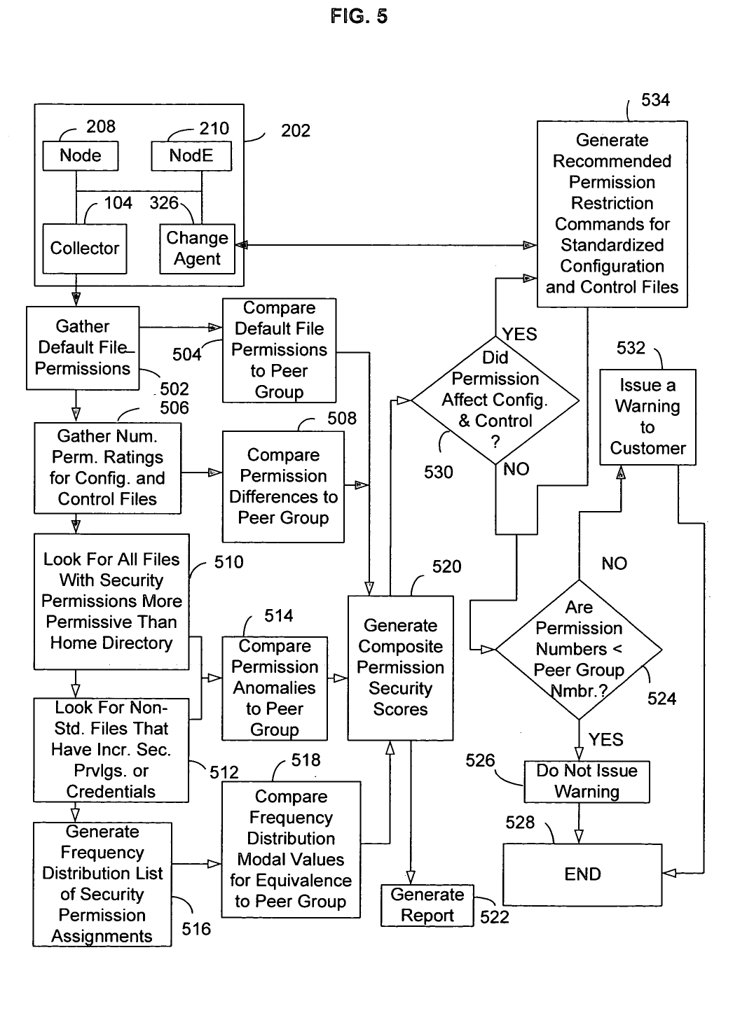

FIG. 5 presents a detailed block diagram of another exemplary embodiment of a security auditing process in which the permission content of the security configuration information associated with data files of all types is evaluated and also may be corrected.

In FIG. 5, the enterprise 202 is again shown to have the two nodes 208 and 210. While only two nodes are shown, many more could be present within the enterprise. The nodes in this case may be servers, workstations, PCs, storage servers, and any other device that provides secure storage of data in files within an enterprise, including tape libraries, RAID style arrays of disk drives, and other hardware storage devices.

File security data for each data file is first collected from the nodes 208 and 210 by the collectors 104 and passed through the web server 220 (FIGS. 2 and 4) to the repository server 234 where the data is stored in the tracker or repository database 106. The collectors 104 here may be programs, scripts, or other systems installed and later periodically placed into data gathering operation by the workflow server 236 and remote connection server 223 or they may be system commands provided to and executed by the operating systems of the nodes 208 and 210 periodically or upon demand, or they may be part of a resource kit that is loaded onto one or more nodes 208 and 210 and then executed on these remote nodes to collect the necessary data and then return it to the central site 218 for evaluation, analysis, and comparison. In some cases, the data may be conveyed by telephone or on removable media.

At step 502 in FIG. 5, the default “file permissions” or, more generally speaking, the default “object permissions” associated with each individual user account are obtained. This is done on each node 208 and 210 by making repeated calls to the UNIX operating system's function “umask” (or to an equivalent function supported by some version of the Windows operating system). Briefly summarized, the permissions associated with any file are three—read permission (permission to read from a file), write permission (permission to write to a file), and execute permission (permission to execute a file containing an executable program or shell script). (Slightly different permissions are associated with files that are directories of other files.)

The “umask” function call returns a 3-digit (sometimes a 4-digit) number, with each of the 3 digits being an “octal” number ranging from 0 to 7 that is represented internally by a 3-bit “octal” digit. Each of the three digits defines a default set of file or object access permissions for a defined set of one or more users, as follows:

The left-most digit defines the file access permissions which the user of an account grants to himself or herself—normally “7”, meaning all permissions are granted. The middle digit defines the file access permissions which the user of the account grants to members of the group of which the user is a member, typically “3”, meaning only “read” and “execute” permissions are granted. The right-most digit defines the access permissions the user of the account grants to all other users, typically “0”, meaning no file access permissions are granted. Thus, a typical response to a call to the function “umask” might return the three digits “730,” meaning that the user of this account has granted himself or herself all three permissions, has granted the members of that user's group read and execute permissions, and has granted all other users no permissions.

These are called “default” permissions because they are assigned to each file or object whenever a user first creates a new file or object. After a file is created, its owner may change the permissions granted through use of the UNIX change mode command “chmod”. The “default” permissions assigned to a given user are determined by enterprise management, and they may be reduced by individual users, if desired, through a different account initialization use of the umask command placed into the individual user's “login” or “profile” file.

The numbers returned by the function “unmask” when it is used to determine the default permissions can have the following values and meanings:
“0”=NO ACCESS to this file is granted;
“1”=permission is granted to EXECUTE this file;
“2”=permission is granted to WRITE to this file;
“3”=permission is granted to EXECUTE and to WRITE to this file;
“4”=permission is granted to READ from this file;
“5”=permission is granted to EXECUTE and to READ from this file;
“6”=permission is granted to WRITE to and to READ from this file; and
“7”=permission is granted to EXECUTE, to WRITE to, and to READ from this file.

At step 504, all of the default file permissions gathered in step 502 are compared to the default file permissions that have previously been found in a comparable peer group of enterprises (or, alternatively, found in an industry standard). This comparison, for example, may begin by selecting only the digits that represent default permissions granted by each user to others not in that user's group; by then computing the average value for this default permission value for the enterprise; and by then comparing this average value to average values computed in the same manner for other comparable peer group enterprises and averaged together for comparison purposes. Or, in some cases, the average default permission value may be compared to industry-wide standards that are established. The comparison may be different for differing industries. For example, the “averaging” process above may be suitable for use in a university, but in a military setting, applicable government-mandated standards may set firm limits on what permissions are allowable, thus causing security warnings to be issued if even one or a few user accounts have default security settings that exceed certain limits. The resulting comparative results, normalized, at step 520 can be combined with other measures of file system security and presented as the “PERMISSIONS” value shown in FIG. 6.

Execution then proceeds from step 502 to step 506, where numerical permission ratings are gathered from specified configuration and control files (e.g., the files ending in the prefixes *.cfg, *.ini, and *.rc, as well as files containing passwords) that are identified in official security bulletins or other documents as being highly sensitive and essential to the proper operation of each node.

Next, at step 508, the variances or permission differences found in this area are compared to the permission differences found with comparable peer group enterprises (for example, the enterprise being monitored and the peer group members all are offering health care and social assistance services, which is classified in NAICS industry group number 62).

At step 510, another search is made for specific files, including standardized configuration and control files, whose assigned file access permissions are less restrictive (against access) than the permissions that are assigned (by enterprise management) to the “home” directories of the users who own these same files. Typically, all files created and modified within a home directory inherit the same permission levels assigned to the home directory itself. Such files can later lose these “default” permissions when the files are moved about or when their permissions are actively modified by the file's owner using the UNIX file permission change mode command “chmod.” The purpose of this test is to count the files that have been actively modified such that their security restrictions are loosened below the levels set by the home directory of the file's owner.

In the prior art, the audits that generate security logs are typically configured (as a matter of default) to monitor instances of all security policy modifications, including those that tighten security as well as those that loosen security or simply change security. The test just described, in contrast, tests for permissions assigned to a file or a directory that are more permissive than a very specific security restriction level, such as (for example) owner=R, group=R, and world=R (also known as owner=4, group=4, world=4 or 444).

Such permission anomalies are counted and are compared to the total number of enterprise files. The relative number of files having anomalous permissions is later used (at step 514) in the comparison of this enterprise's security level in this general area to that of a peer group of enterprises. Then the result of this comparison is later used (at step 520) in the generation of the composite permission security code scores for this enterprise, which are displayed as “permissions” at 600 in FIG. 6.

In addition, if this test reveals that a file is not adequately secured, and if the file is also a standardized configuration and control file, this is detected later on at step 530. Such a file's permissions may be automatically adjusted or repaired at step 534. For example, if a password file named “/etc/passwd” (the file named “passwd” in the directory “/etc/”) is missing a specific access restriction in any of the file security segments “owner”, “group”, or “world” that is mandated by the enterprise management, then this is noted at step 530 which responds by causing the step 534 to be executed. For each such under-secured standardized configuration and control file, step 534 sends a message over the network to the enterprise 202 which causes a change agent 326 within the enterprise to generate, on the node where the defectively-secured file resides, a command that applies the specific permission required by enterprise management to this password file.

As an example of a commercial off-the-shelf change agent, one may use “RSH”. This program comes included with UNIX. For Windows NT users, “RSH NT” is an optional add-on product.

In this case, the change agent 326 might generate the command:
“chmod 555/etc/passwd”
or, as another example, to correct security levels assigned to the file “.procmailrc,” it might generate the command:
“chmod 500/home/$USERNAME/.procmailrc”

These two commands cause the permissions on the files “/etc/passwd” and “home/$USERNAME/.procmailrc” to be set such that these files will thereafter pass this particular security test. System security is thereby reestablished automatically for such files following the security check procedure.

Common examples of configuration and control file names that may be automatically have their security settings reset in this manner are the following: “/etc/passwd”; “/etc/hosts”; “/etc/services”; “/home/$USERNAME/.rhosts”; “/home/$USERNAME/.login”; “/home/$USERNAME/.cshrc”; “/home/$USERNAME/.tcshrc”; “/home/$USERNAME/.profile”; and “/home/$USERNAME/.procmailrc”.

From step 510, execution proceeds to the step 512 where a search is made for non-standard programs and files that have the ability to act in insecure ways or that have the necessary permissions to change the security credentials of other system elements. For example, certain UNIX programs, called “SetUID” programs, operate not at the security level assigned a given user but at a more permissive security level. Included in this category are such basic UNIX system utilities as “eject”, “passwd”, “login”, “su”, “rcp”, “ufsdump”, “w”, “ping”, and “uptime”. Each of these system programs allows its user to temporarily masquerade as another user (for example, as a privileged system administrator) for a brief time to enable the user to perform some very specific and carefully controlled task. One may also find unusual security settings associated with well-intentioned and well-tested programs such as the “sendmail” program which has, for historic reasons, allowed its users to go beyond their normal security limits, again for some very specific and carefully controlled purpose. Unlike these well-behaved and carefully-tested system utilities, “SetUID” programs written by individual users or created for use at one site or within one organization may be far less well-tested, and in some cases they may also be far less well-intentioned. These are more likely to be capable of performing unacceptable security exploits.

Accordingly, at step 512, a search is made for such programs. These programs have their “SetUID” flag set equal to zero. This search also looks for Administrator ID programs that may allow their users to become privileged system administrators and then violate security boundaries. The relative number of such programs on any given machine or within any given enterprise, along with the results of the tests performed at step 510, are both compared at step 514 to peer group information.

Next, in the step 516, a frequency distribution list of the security assignments assigned to all files and directories is computed for the nodes or for the enterprise. At step 518, modal values (the most frequently found values) are derived from this list and are compared to frequency distribution modal values that are obtained from the relevant peer group.

Finally, at step 520, The results of all the comparisons performed at the steps 504, 508, 514 and 518 are combined to determine composite security scores which are presented in a security report at 522. When scores are combined at step 520, one possible way to do this is to assign half the weight of the security permission scores to the relative deviation of the enterprise modal values from the peer group norms. Half the weight is assigned to the tests of individual file permission settings which emerge when the inconsistencies in such settings in comparison with the peer group are identified. In this manner, the final overall score partly reflects the extent to which the security of all files varies from the desired norms, and it partly reflects the extent to which individual files are found to be out of the normal limits. The aggregate score can take into account the importance of each type of file by giving a greater weight to the more important files from a security standpoint, to the extent that they can be identified. A report is then generated to show the results of the comparisons and the composite scores at step 522. Then, at steps 530 and 534, the security of configuration and control files is restored, as has already been explained.

At step 524, the computed overall permission security scores are compared to the industry averages. If the composite permission security scores are less than or equal to the industry averages, then program execution proceeds to step 526, and a warning is not issued to the enterprise management. If the composite permission security scores are lower than the industry averages, then a warning to enterprise management is issued at step 532.

FIG. 6 is a circular graph or plot or report 600 illustrating the results of a security audit or assessment rating. The portion shaded with shading lines slanting from upper-right to lower-left represents the enterprise's ratings in percentages, and the portion shaded with shading lines slanting from upper left to lower right represents the industry average ratings in percentages.

The “Overall” security rating is expressed along a vertical line extending upwards from the circular graph 600, as can be seen in FIG. 6.

On the right half of the graph 600, there is shown the specific security audit configuration information that is accessed and evaluated automatically. This type of security information is categorized as follows:
1. “Other”
2. “Settings”
3. “Permissions”
4. “Password”
5. “Logging”
6. “Network”
7. “Setuid Pgm”
8. “Patches”
9. “Daemons”

On the left half of the graph 600, there is shown the security audit information that requires some degree of user involvement or input, as from user interviews. The security information is categorized as follows:
1. “Assumptions”:
2. “Personnel Review”:
3. “Audit Frequency”:
4. “Security Policies”:
5. “Physical Security”:
6. “Risk Management”:
7. “Threat Evaluation”:
8. “Application’
9. “Trust Dependency”:

There are some security-related questions that can only be addressed by interviewing a human user or manager, since the information is not stored predictably anywhere on a device attached to the enterprise network. Specific examples of the above include physical security measures which have questions (see, for example, Appendix C) that cannot presently be answered by computers such as on the topic of security policies and whether they are actually being practiced by all users. Illustrative examples of such questions are provided in the three Appendices A, B, and C.

The foregoing description of a preferred embodiment of the invention has been presented for purposes of illustration and description. It is not intended to be exhaustive or to limit the invention to the precise form disclosed and modifications and variations are possible in light of the above teachings or may be acquired from practice of the invention. The embodiment was chosen and described to explain the principles of the invention and its practical application to enable one skilled in the art to utilize the invention in various embodiments and with various modifications suited to the particular uses contemplated. It is intended that the scope of the invention be defined by the claims appended hereto and their equivalents.

References:

Aamodt, M. G., Applied Industrial/Organizational Psychology, 3^{rd} Ed., Wadsworth Pub. Co., Belmont, Calif., 1991.
U.S. Congress, Office of Technology Assessment, “The Use of Integrity Tests for Pre-Employment Screening”, OTA-SET-442, NTIS order #PB91-107011, Washington, D.C.: U.S. Government PRinting Office, September 1990, p. 1-3,29-33.
Tipton, H. F., and Krause, M., (2000), Information Security Management Handbook, 4^{th} Ed., CRC Press LLC, New York: 2000.
Sackett, P., Burris, L., and Callahan, C. “Integrity Testing for Personnel Selection: An Update;” Personnel Psychology, vol. 42, 1989.
Stone, L. A., Manual: personnel security Standards psychological Questionnaire, Harpers Ferry, W. Va.: Author, 1986.

### Appendix A

### Sample Personnel Review Questions

### Modified OTA Report—Step 709 in FIG. 7

### Used to Compute “Personnel Review” at 600 in FIG. 6

1. How often do you tell the truth?

A. Always, B. Most of the time, C. Some of the time, D. Rarely, E. Never
2. Do you think you are too honest to take something that is not yours?”

A. Always, B. Most of the time, C. Some of the time, D. Rarely, E. Never
3. How much do you dislike doing what someone tells you to do?

A. Very strongly, B. Strongly, C. Weakly, D. No problem
4. Do you feel guilty when you do something you think you should not do?

A. Always, B. Most of the time, C. Some of the time, D. Rarely, E. Never
5. Do you think it is stealing to take small items home from work?

A. Always, B. Most of the time, C. Some of the time, D. Rarely, E. Never
6. Do you believe that taking paper or pens without permission from a place where you work is stealing?

A. Always, B. Most of the time, C. Some of the time, D. Rarely, E. Never
7. What percentage of the people you know are so honest they would not steal at all?

A. Virtually all, B. Between half and all, C. Half, D. Less than half, E. None
8. How many people have cheated the government on their income tax returns?

A. Virtually all, B. Between half and all, C. Half, D. Less than half, E. None
9. How easy is it to get away with stealing?

A. Extremely easy, B. somewhat easy, C. difficult, D. extremely difficult,
10. In any of your other jobs, was it possible for a dishonest person to take merchandise if a dishonest person had your job?

A. Extremely easy, B. somewhat easy, C. difficult, D. extremely difficult,
11. Do you believe most employers take advantage of the people who work for them?

A. Extremely easy, B. somewhat easy, C. difficult, D. extremely difficult,
12. Do you think company bosses get away with more illegal things than their employees?

A. Extremely easy, B. somewhat easy, C. difficult, D. extremely difficult,
13. True or False: Eating right is important to my health:

A. True, B. False,
14. True or False: I like to create excitement.

A. True, B. False,
15. How often during the week do you go to parties?

______ (Numeric Answer)
16. True or False: I am usually confident about myself.

A. True, B. False,
17. True or False: A lot of times I went against my parents' wishes.

A. True, B. False,
18. I feel lonely even when I am with other people.

A. All the time, B. Most of the time, C. Sometimes, D. Almost never, E. Never
19. How often do you blush?

______ (Numeric Answer)
20. How often do you make your bed

A. Every day, B. Most days, C. Sometimes, D. Almost never, E. Never
21. How many people do you dislike?

______ (Numeric Answer)
22. Are you an optimist?

A. All the time, B. Most of the time, C. Sometimes, D. Almost never, E. Never

### Appendix B

### Sample Physical Security Questions

### Step 711 in FIG. 7

### Used to Compute “Physical Security” at 600 in FIG. 6

To be answered: “YES” or “NO”

(Note: These questions generate +1 point for each “YES” answer.)

1. Is there a monitored burglar alarm with motion sensor coverage, plus door and window sensors on all building openings?

2. Did you observe closed-circuit television cameras at all entrances and exits?

3. Did you observe security guards continuously during business hours?

4. Are the guards posted during business hours armed?

5. Are security guards posted at your facility continuously outside of business hours?

6. Are the guards posted outside of business hours armed?

7. Does your organization use a fire and theft resistant safe to store valuables?

12. Is this safe time-locked to only operate near business hours?

13. Does your organization use dead-bolt locks on all doors?

14. Does your organization have a process for minimizing the likelihood of unauthorized key duplication?

### Appendix C

### Sample Security Policy Questions

### Used to Compute “Security Policies” at 600 in FIG. 6

1. Do you have a property tagging and bar code inventory control process?

2. Does your organization perform inventory checks at least once per year?

3. Does your organization perform inventory checks at least once per month?

4. Does your organization perform inventory checks at least once per week?

5. Are valuables stored in a safe when not in use?

1. A method for auditing the security of an enterprise including plural nodes comprising:
collecting security information from the nodes of the enterprise under audit;
analyzing the security information and providing a first result of this analysis; and
comparing this first result with a second result comprising security standards applicable to the enterprise under audit and one or more other enterprises that together form a relevant peer group, the result of this comparing step indicating the relative security of the enterprise under audit relative to that of the peer group of enterprises.

2. The method of claim 1 wherein, in the comparing step, the second result comprises information derived from industry standards applicable to the relevant peer group of enterprises.

3. The method of claim 1 wherein, in the comparing step, the second result comprises information derived from information previously obtained through application of the collecting and analyzing steps to two or more enterprises in the relevant peer group.

4. The method of claim 1, further comprising the step of generating at least one report that presents the first and second results arranged in a way that facilitates their comparison.

5. The method of claim 4 wherein the generating step includes presenting the first and second results each broken down into several results relating to several different areas of security, with a first and a second result presented for each different area of security and arranged in a way that facilitates their comparison.

6. The method of claim 5 wherein, in the generating step, the results relating to several different areas of security comprise results arising from analysis of personnel security information and physical security information, at least some of the information included in the first result having been gathered using interviews during the collecting step.

7. The method of claim 5 wherein, in the generating step, the results relating to several different areas of security comprise results arising from analysis of password security information and file access permission security information.

8. The method of claim 7 wherein, in the generating step, the results relating to several different areas of security further comprise results arising from analysis of personnel security information and physical security information, at least some of the information included in the first result having been gathered using interviews during the collecting step.

9. The method of claim 5 wherein, in the generating step, the several different areas of security comprise one or more results of analysis of node configuration security information and one or more results of analysis of security information gathered using interviews.

10. The method of claim 9 wherein, in the generating step, the one or more results of analysis of node configuration security information comprise results arising from analysis of password security information.

11. The method of claim 9 wherein, in the generating step, the one or more results of analysis of node configuration security information comprises results arising from analysis of file access permission security information.

12. The method of claim 4, wherein the generating step generates at least two comparative reports in different formats for different requesting parties or uses, and in particular one for technical experts that includes technical language and details and another for non-technical-experts that substantially excludes technical language and details.

13. The method of claim 1, to which is added:
generating and executing commands to alter the security information of one or more nodes to improve system security in at least some cases when the analysis or comparison or both indicate security is in need of improvement.

14. The method of claim 13, further comprising;
generating at least one report that presents the first and second results arranged in a way that facilitates their comparison.

15. The method of claim 13 wherein the generating commands step generates commands which force the deactivation or correction of one or more passwords when the analysis or comparison or both indicate that these one or more passwords are not sufficiently secure.

16. The method of claim 13 wherein the generating commands step generates commands which force alteration of one or more configuration file or control file access permissions if the analysis or comparison or both indicate that the access permissions assigned to these one or more files do not provide adequate system security.

17. A system for auditing the security of an enterprise comprising:
a plurality of nodes within the enterprise under audit;
collectors associated with the nodes and arranged to collect from the nodes information concerning the security of the enterprise under audit;
a security analyzer arranged to analyze the information concerning the security of the enterprise under audit and to provide a first result of this analysis;
a data base containing a second result comprising security standards applicable to the enterprise under audit and one or more other enterprises that together form a relevant peer group; and
a comparison mechanism arranged to compare the first and second results to determine the relative security of the enterprise under audit in comparison to that of the enterprises in the relevant peer group.

18. A system in accordance with claim 17 to which is added:
a report generator that generates at least one report which presents the first and second results arranged each broken down into several results relating to several different areas of security, with a first and second result presented for each different area of security and arranged in a way that facilitates their comparison.

19. A system in accordance with claim 17 to which is added:
change agents associated with the nodes and able to execute commands that alter node configuration information; and
a command generator that provides commands to the change agents on selected nodes to alter node configuration information to improve system security in response to the analyzer or comparison mechanism or both determining security improvements are needed.

20. A system in accordance with claim 19 wherein the command generator includes a mechanism that can generate commands which, when executed, cause one or more of the change agents to force the deactivation or correction of one or more secure passwords if the security analyzer or comparison mechanism or both determine that one or more passwords are not sufficiently secure.

21. A system in accordance with claim 19 wherein the command generator included a mechanism that can generate commands which, when executed, cause one or more of the change agents to force the alteration of the access permissions of one or more configuration files or control files if the security analyzer or comparison mechanism or both determine that the access permissions assigned to one or more such files do not provide sufficient security.

22. A system for auditing the security of an enterprise comprising:
a plurality of nodes within an enterprise under audit;
collector means associated with the nodes for collecting information from the nodes concerning the security of the enterprise under audit;
security analyzer means for analyzing the information concerning the security of the enterprise under audit and for providing a first result of this analysis;
data base means for storing and for presenting a second result comprising security standards applicable to the enterprise under audit and one or more other enterprises that together form a relevant peer group; and
comparison means for comparing the first and second results to determine the relative security of the enterprise under audit in comparison to that of the enterprises in the relevant peer group.

23. A system in accordance with claim 22 to which is added
report generation means for generating at least one report which presents the first and second results each broken down into several results relating to several different areas of security, whith a first and second result presented for each different area of security and arranged in a way that facilitates their comparison.

24. A system in accordance with claim 22 to which is added
change agent means associated with the nodes for executing commands that alter node configuration information; and
command generator means for providing commands to the change agent means on selected nodes as needed to alter system configuration information to improve system security in response to the security analyzer means or the comparison means or both determining that security improvements are needed.
